(19) United States
(12) Patent Application Publication
(10) Pub. No.: US 2008/0084303 A1
(43) Pub. Date: Apr. 10, 2008

(54) Security container

(75) Inventors: Stewart J. Herd, Perth & Kinross (GB); Barrie Clark, Dundee (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/544,373

(22) Filed: Oct. 6, 2006

(51) Int. Cl. G08B 13/14; G08B 21/00

(52) U.S. Cl. 340/568.1; 340/686.1; 340/612

(57) ABSTRACT

A security container comprises a body and a secure opening, each of which is formed from inner and outer walls. The space between the walls is filled with a fluid and a fluid sensor is located so as to detect changes in the fluid. The sensor is coupled to a security system, which is activated on the triggering of the sensor.

### TECHNICAL FIELD

The present invention relates to a security container, which may be a safe for an Automated Teller Machine (ATM) which dispenses or receives cash, or a conventional safe.

### BACKGROUND

ATMs utilize two main types of protection for the valuable media stored therein, solid physical protection in the form of a traditional thick steel walled safe and electronic protection normally in the form of a sensor mat which is formed to correspond to a specific safe layout. The sensor mat is connected to an ink staining system, such as that sold by Fluiditi Limited, of Portsmouth England.

Each of these aspects of convention safe design is problematical. The existing safe construction normally consists of thick steel walls, top and floor, which is sometimes enhanced by a cement layer. Both the normal construction and the cement layer cause conventional safes to be very heavy and difficult to maneuver.

The sensor mats must be formed to the exact shape of the interior of the safe so that there is no vulnerable spot not covered by the mat. Damage to the mat by a drill bit or the like is detected as an open or short circuit, depending on mat design, and an alarm signal is activated. An alarm may then be sounded or the signal from the mat may cause an ink dispersal system to be activated to mark the valuable media within the safe, as mentioned above.

Therefore, it would be desirable to provide a security container which ameliorated one or more of the problems detailed herein.

### SUMMARY

It is an object of the present invention to provide an enhanced security container while reducing the costs and complexity thereof.

In accordance with an embodiment of one aspect of the present invention there is provided a security container comprising a body and a secure opening, each of which is formed from inner and outer walls, said walls forming an enclosed space there between, said space being filled with a fluid, a fluid sensor located so as to detect a change in the fluid and to produce a triggering signal on the detection of said change.

Preferably, the sensor is coupled to a security system, which is activated on the triggering of the sensor.

Preferably, the fluid is pressurized, and the sensor is arranged to detect a change in pressure caused by an attack on one or more of the walls or secure opening of the security container, and to activate the security system.

Alternatively, wherein the fluid is formed from a liquid which changes state as a result of being exposed to the external air, if one or more of the wall or the secure opening is attacked and the sensor is arranged to identify this change of state and to activate the security system.

In a preferred embodiment the secure opening is a hinged door and the body and secure opening are formed from 12.5 mm (0.5 inch) toughened steel plate.

Preferably the pressure fluid is a gas.

Preferably the security system includes an alarm and or an ink dispersal system.

Still more preferably the ink dispersal system is located within a currency cassette and only coupled to the sensor when the cassette is secured in the security container.

Preferably the security system includes a secure wireless communications system

In one embodiment a portion of the space is filled with cement, so as to enhance the physical security of the container.

### BRIEF DESCRIPTION OF THE DRAWINGS

Additional benefits and advantages of the present invention will become apparent to those skilled in the art to which this invention relates from the subsequent description of an embodiment, taken in conjunction with the accompanying drawings, in which:

FIG. 1 is schematic view of a security container in accordance with the present invention;

FIG. 2 is a cross-section of the body of security container of FIG. 1; and

FIG. 3 is a schematic view of the security container of FIG. 1, wherein the alarm is a remote alarm.

### DETAILED DESCRIPTION

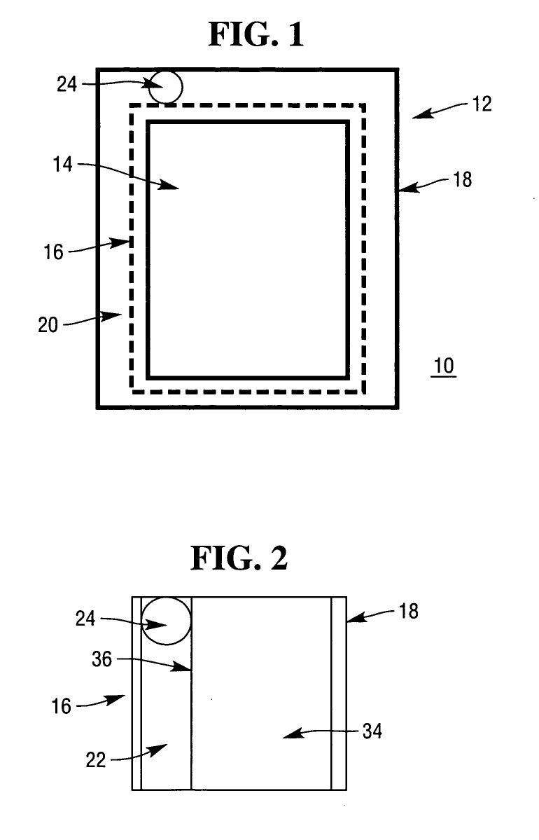

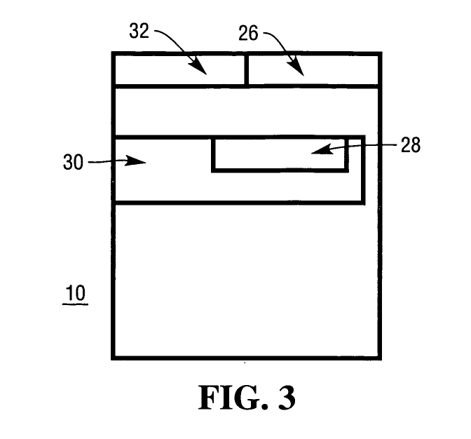

Referring now to FIG. 1, there is illustrated a security container (10) comprising a body (12) and a secure opening (14), in the form of a hinged door. Each of which is formed from inner and outer walls (16, 18), which form an enclosed space (20) there between. The space is filled with a fluid (22) and contains a fluid sensor (24) located so as to detect a change in the fluid. As will be detailed below the sensor (24) is arranged to produce a triggering signal on the detection of a predetermined change in the fluid (22). The sensor is coupled to a security system (26, 28), which is activated on the triggering of the sensor (24).

The body (12) and secure opening (14) are formed from 12.5 mm (0.5 inch) thick toughened steel plate.

In one embodiment the fluid is pressurized, and the sensor (24) is arranged to detect a change, most normally a reduction, in pressure caused by an attack on one or more of the walls (18) or secure opening (14) of the security container (10). On detecting this change in pressure the sensor (24) activates the security system (26, 28), which will be described below. The pressure sensor is a fast response sensor which will detect and respond to the drop in gas pressure prior to an explosion if the safe is under attack.

In most cases the fluid will be a gas, although assuming an appropriate choice of sensor the fluid can also be a liquid.

In a second embodiment the fluid is formed from a liquid which changes state as a result of being exposed to the external air.

If during an attack one or more of the wall (18) or the secure opening (14) is damaged causing the fluid to come into contact with the environment the sensor will detect a change in the state of the fluid and activate the security system (26, 28), as detailed below.

In one embodiment the security system includes an alarm (26) which is arranged to signal the attack on the secure container. The alarm may be a local alarm which may be designed to cause a great deal of noise in the vicinity of the security container and hence cause the attackers to panic and desist.

In another embodiment the alarm is a remote alarm, which will notify the authorities of the attack on the security container (10). In this case the security system further includes a secure wireless communications system (32) between the security container (10) and the remote alarm.

In yet a further embodiment the security system includes an ink dispersal system (28). Ideally, in ATM security container the ink dispersal system is located within a currency cassette (30) and only coupled to the sensor (24) when the cassette (30) is secured in the security container (10).

In some instances, say, if the security container (10) is intended to for use in particular insecure environment or if it is to hold a significant amount of valuables, a portion of the space is filled with cement (34), so as to enhance the physical security of the container and a thin sheet metal plate (36) is located between the cement (34) and the fluid (22).

Although the invention has been described with particular reference to certain preferred embodiments thereof, variations and modifications of the present invention can be effected within the spirit and scope of the following claims.

What is claimed is:

1. A security container comprising a body and a secure opening, each of which is formed from inner and outer walls, said walls forming an enclosed space there between, said space being filled with a fluid, a fluid sensor located so as to detect a change in the fluid and to produce a triggering signal on the detection of said change.

2. A security container as claimed in claim 1, wherein the sensor is coupled to a security system, which is activated on the triggering of the sensor.

3. A security container as claimed in claim 2, wherein the fluid is pressurized, and the sensor is arranged to detect a change in pressure caused by an attack on one or more of the walls or secure opening of the security container, and to activate the security system.

4. A security container as claimed in claim 3, wherein the pressure fluid is a gas.

5. A security container as claimed in claim 1, wherein the fluid is a liquid.

6. A security container as claimed in claim 1, wherein the fluid is formed from a liquid which changes state as a result of being exposed to the external air, if one or more of the wall or the secure opening is attacked and the sensor is arranged to identify this change of state and to activate the security system.

7. A security container as claimed in claim 1, wherein the secure opening is a hinged door.

8. A security container as claimed in claim 1, wherein the body and secure opening are formed from 12.5 mm (0.5 inch) thick toughened steel plate.

9. A security container as claimed in claim 1, wherein the security system includes an alarm.

10. A security container as claimed in claim 9, wherein the alarm is a remote alarm.

11. A security container as claimed in claim 1, wherein the security system includes an ink dispersal system.

12. A security container as claimed in claim 11, wherein the ink dispersal system is located within a currency cassette and only coupled to the sensor when the cassette is secured in the security container.

13. A security container as claimed in claim 10, wherein the security system includes a secure wireless communications system

14. A security container as claimed in claim 1, wherein a portion of the space is filled with cement, so as to enhance the physical security of the container.

15. A security container as claimed in claim 14, wherein a thin sheet metal plate is located between the cement and the fluid.
